(19) United States
(12) Patent Application Publication
(10) Pub. No.: US 2024/0420581 A1
(43) Pub. Date: Dec. 19, 2024

(54) METHODS AND SYSTEM USING MOBILE NETWORK MULTICAST AND BROADCAST FUNCTION TO SUPPORT UAS DAA

(71) Applicant: Huawei Technologies Co., Ltd., Shenzhen (CN)

(72) Inventors: Zhixian Xiang, Frisco, TX (US); Kaippallimalil Mathew John, Carrollton, TX (US); Khosrow Tony Saboorian, Plano, TX (US)

(21) Appl. No.: 18/819,851

(22) Filed: Aug. 29, 2024

Related U.S. Application Data
(63) Continuation of application No. PCT/US2023/016723, filed on Mar. 29, 2023.
(60) Provisional application No. 63/326,980, filed on Apr. 4, 2022.

(51) Int. Cl. G08G 5/00; H04W 48/16; H04W 48/18

(52) U.S. Cl. CPC G08G 5/0069; G08G 5/0013; H04W 48/16; H04W 48/18

(57) ABSTRACT

An uncrewed aerial system (UAS) receives, from a first network function device of a first network, a network selection policy indicating a second network providing local UAS traffic information. The UAS receives from a second network function device of the second network, uncrewed aerial system traffic management (UTM) support information, and selects the second network in accordance with the network selection policy and the UTM support information. The UAS connects to the second network function device of the second network to receive the local UAS traffic information from the second network function device.

### CROSS-REFERENCE TO RELATED APPLICATIONS

This patent application is a continuation of International Application PCT/US2023/016723 filed on Mar. 29, 2023 and entitled “Methods and System Using Mobile Network Multicast and Broadcast Function to Support UAS DAA,” which claims the benefit of U.S. Provisional Patent Application No. 63/326,980 filed on Apr. 4, 2022 and entitled “New Mechanism for Using Mobile Network Multicast and Broadcast Function to Support UAV DAA (Detection and Avoidance),” which applications are hereby incorporated herein by reference.

### TECHNICAL FIELD

The present disclosure relates generally to methods and system for uncrewed aerial system (UAS) traffic management and, in particular embodiments, to methods and systems for using mobile networks to support UAS detect and avoid (DAA) assistance.

### BACKGROUND

There are efforts in 3GPP to integrate the UAS (e.g., an uncrewed aerial vehicle (UAV) or a drone) into the mobile 4G/5G/6G network systems. These efforts not only allow the UAS to support base station (e.g., gNB) functionality for providing mobile access, but also leverage mobile communication capabilities used by the UAS to integrate a mobile network into a global UAS traffic management system and to support various UAS applications. 3GPP SA2 has created a new normative specification (TS23.256) in Release 17 for on supporting UAV identification, tracking, and connectivity. SA2 and RAN2 also have new Release 18 study items on further enhancing 5G system for a UAV system. Both study items include objectives on how to use the mobile network to support detect and avoid (DAA) assistance by providing surrounding traffic information to the cell connected to the UAV and the UAV's controllers.

### SUMMARY

Technical advantages are generally achieved by embodiments of this disclosure which describe methods and apparatus for using mobile network multicast and broadcast functions to support UAS DAA in this disclosure.

For ease of explanation, some embodiments in this disclosure are described using the UAV as the example. These embodiments can be applied using the UAS in general (which may be the UAV, the UAV controller controlling the UAV, or a combination of the UAV and the UAV controller).

According to embodiments, an uncrewed aerial system (UAS) receives, from a first network function device of a first network, a network selection policy. The network selection policy indicates a second network providing local UAS traffic information. The UAS receives from a second network function device of the second network, uncrewed aerial system traffic management (UTM) support information. The UAS selects the second network in accordance to the network selection policy and the UTM support information. The UAS connects to the second network function device of the second network to receive the local UAS traffic information from the second network function device.

In some embodiments, the first network may be a home network that the UAS subscribes to. The second network may be different from the first network.

In some embodiments, the second network may be part of a network of the base station or of a cell of the base station.

In some embodiments, the UTM support information may be broadcast by the second network function device.

In some embodiments, the local UAS traffic information may be multicast or broadcast by the second network function device. In some embodiments, the second network function device may be the base station or an internet protocol (IP) based function device.

In some embodiments, the local UAS traffic information may be unicast by the second network function device.

In some embodiments, the UTM support information may indicate that the second network function device of the second network supports UTM including at least one of UAS identification or UAS detect and avoid (DAA).

In some embodiments, the second network function device may be a ground-based base station. The UAS may be at least one of an uncrewed aerial vehicle (UAV), a UAV controller controlling the UAV.

In some embodiments, the network selection policy may include at least one of a candidate network identifier (ID) or a candidate DAA ID. The UTM support information may include a network ID of the second network and a DAA network ID. In some embodiments, the DAA network ID may indicates that a network is for UTM. The DAA network ID may be different from any network ID(s) for providing other different non-UAS service(s). In some embodiments, the UE may select the second network based on the network ID in the UTM support information matching the candidate network ID in the network selection policy and the DAA network ID in the UTM support information matching the candidate DAA ID in the network selection policy. In some embodiments, the UE may select the second network based on a coverage area in which the UAS is located and a candidate coverage area indicated in the UTM support information. In some embodiments, the UAS may provide location information to the second network function device. The second network function device may provide traffic information tailored to a group of joined member devices based on information from the joined member devices in the group, and the group may include the UAS.

In some embodiments, wherein the network selection policy may further define a selection granularity per network, or per cell of the second network.

According to embodiments, the second network function device of the second network transmits to an uncrewed aerial system (UAS), uncrewed aerial system traffic management (UTM) support information. The UAS receives from a first network function device of a first network, a network selection policy indicating the second network providing local UAS traffic information. The UAS selects the second network in accordance to the network selection policy and the UTM support information. The second network functioned device of the second network connects with the UAS to transmit the local UAS traffic information from the second network function device.

In some embodiments, the first network may be a home network that the UAS subscribes to. The second network may be different from the first network.

In some embodiments, the second network may be part of a network of the base station or of a cell of the base station.

In some embodiments, the UTM support information may be broadcast by the second network function device.

In some embodiments, the local UAS traffic information may be multicast or broadcast by the second network function device. In some embodiments, the second network function device may be the base station or an internet protocol (IP) based function device.

In some embodiments, the local UAS traffic information may be unicast by the second network function device.

In some embodiments, the UTM support information may indicate that the second network function device of the second network supports UTM including at least one of UAS identification or UAS detect and avoid (DAA).

In some embodiments, the second network function device may be a ground-based base station. The UAS may be at least one of an uncrewed aerial vehicle (UAV) or a UAV controller controlling the UAV.

In some embodiments, the network selection policy may include at least one of a candidate network identifier (ID) or a candidate DAA ID. The UTM support information may include a network ID of the second network and a DAA network ID. In some embodiments, the DAA network ID may indicate that a network is for UTM. The DAA network ID may be different from any network ID(s) for providing other different non-UAS service(s). In some embodiments, the UE may select the second network based on the network ID in the UTM support information matching the candidate network ID in the network selection policy and the DAA network ID in the UTM support information matching the candidate DAA ID in the network selection policy. In some embodiments, the UE may select the second network based on a coverage area in which the UAS is located and a candidate coverage area indicated in the UTM support information. In some embodiments, the UAS may provide location information to the second network function device. The second network function device may provide traffic information tailored to a group of joined member devices based on information from the joined member devices in the group, and the group may include the UAS.

In some embodiments, the network selection policy may further define a selection granularity per network, or per cell of the second network.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1A illustrates an example communications system 100, according to embodiments;

FIG. 1B illustrates a mobile network architecture to support UAV, according to embodiments;

FIG. 2 shows an example architecture of an embodiment solution;

FIG. 3A shows a flow chart for selection of a DAA information broadcast network, according to some embodiments;

FIG. 3B shows a flow chart for the UE to receive the DAA information, according to some embodiments;

FIG. 4A illustrates a flow chart of a method performed by a UAS, according to some embodiments;

FIG. 4B illustrates a flow chart of a method performed by a base station, according to some embodiments;

FIG. 5 illustrates an example communication system 500, according to some embodiments;

FIGS. 6A and 6B illustrate example devices that may implement the methods and teachings according to this disclosure; according to some embodiments; and

FIG. 7 shows a block diagram of a computing system that may be used for implementing the devices and methods disclosed herein, according to some embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

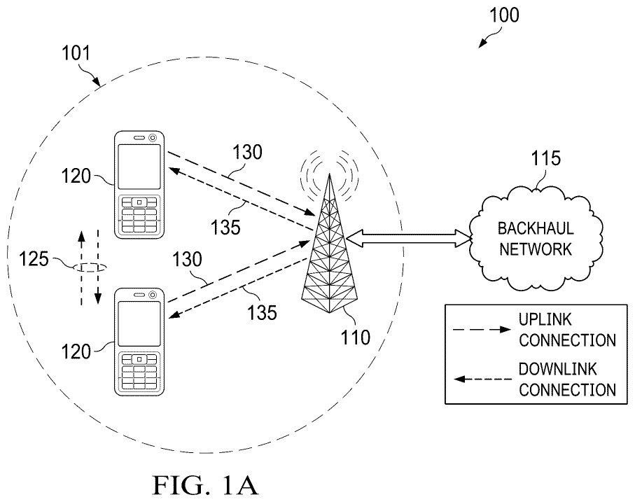

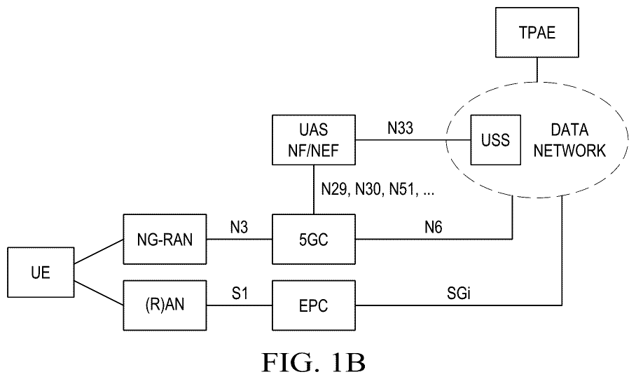

FIG. 1A illustrates an example communications system 100, according to embodiments. Communications system 100 includes an access node 110 serving user equipment (UEs) with coverage 101, such as UEs 120. In a first operating mode, communications to and from a UE passes through access node 110 with a coverage area 101. The access node 110 is connected to a backhaul network 115 for connecting to the internet, operations and management, and so forth. In a second operating mode, communications to and from a UE do not pass through access node 110, however, access node 110 typically allocates resources used by the UE to communicate when specific conditions are met. Communications between a pair of UEs 120 can use a sidelink connection (shown as two separate one-way connections 125). In FIG. 1A, the sideline communication is occurring between two UEs operating inside of coverage area 101. However, sidelink communications, in general, can occur when UEs 120 are both outside coverage area 101, both inside coverage area 101, or one inside and the other outside coverage area 101. Communication between a UE and access node pair occur over uni-directional communication links, where the communication links between the UE and the access node are referred to as uplinks 130, and the communication links between the access node and UE is referred to as downlinks 135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

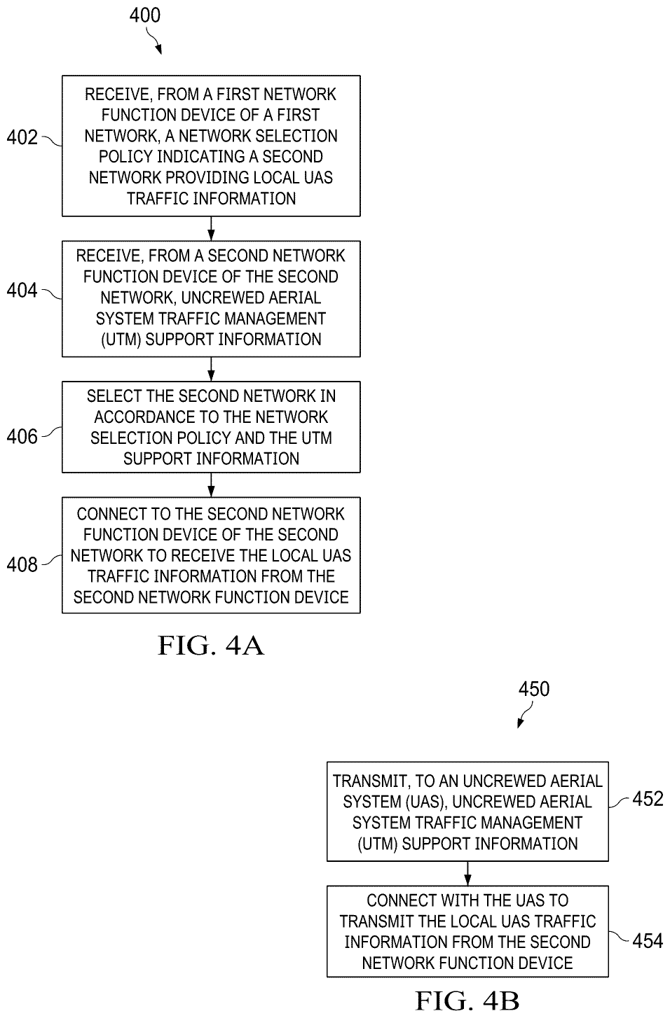

In Release 17, TS23.256 defines a network architecture and listed functionalities which allow the mobile network to work with a UAS traffic management (UTM) system to identify and track the mobile connected UAV and to manage the Control and Command (C2) communication of the UAV. A C2 communication refers to the user plane link to deliver messages with information of command and control for UAV operation from a UAV controller or a UTM to a UAV or to report telemetry data from a UAV to its UAV controller or a UTM. This architecture can be used for UAA DAA also. An example 3GPP defined mobile network architecture to support UAV is illustrated in FIG. 1B, as defined in FIG. 4.2.2-1 of TS23.256, “Support of Uncrewed Aerial Systems (UAS) connectivity, identification and tracking; Stage 2.”

Unlike the traffic management for crewed airplanes, which has well defined and developed DAA mechanisms to prevent collisions between the airplanes, there are no such DAA mechanisms for UASs such as drones. There are joint efforts between global regulatory bodies and industry partners to define such mechanisms. 3GPP SA2 and RAN both created Release 18 self-adaptive intrusion detections (SIDs) to study potential 5G enabled solutions for DAA mechanisms for the drones. One of the main potential directions for the solutions proposed by various companies uses mobile sidelink (PC5 interface), similar to the use cases for vehicle-to-everything (V2X), to allow a UAV to broadcast its position as well as to receive position information from nearby UAVs.

### Limitations of Conventional Systems

The technical problems of the conventional PC5-based-UE-broadcast solutions include the following.

First, the conventional solutions fully rely on a UAS to collect the position information of each surrounding UAS. So, the UAS creates its own picture of the surrounding traffic. The UAS may miss collecting position information for some nearby UASs because of the coverage/blockage issues. In addition, the UAS may not have an accurate picture of traffic due to its own poor implementation of the sidelink.

Second, because of the short distance of the PC5 coverage, the UAS only has the limited-range view of traffic, which may not help the UAS's fly plan for the long distance. It is desirable to have a large area over the coverage area (e.g., on the order greater than a 10 km in diameter). The coverage area for the sidelink is usually on the order of 1-2 km in diameter.

Third, the conventional solutions may require the mobile element (ME) of the UAS to support the PC5 interface, which is an optional feature for most of existing UE implementations.

For crewed airplane DAA, there is an automatic dependent surveillance-broadcast (ADS-B) system in which an airplane not only broadcasts its own position, but also can receive traffic information on dedicated spectrum from a broadcasting ground station via its ADS-B system. The broadcasted traffic information from the ground station provides near real time traffic information in the area.

The existing ADS-B system is an exclusive broadcast system designed for crewed airplane traffic using the dedicated spectrum. However, the existing ADS-B system is not applicable to UASs and does not consider using a mobile network. Therefore, it may be desirable to define a system for UAVs using a mobile network. The European Union Aviation Safety Agency (EASA) is defining an ADS-B -like solution for the UAVs where the PC5 interface is one option.

Currently, there is no 3GPP-based UAV DAA mechanisms. One possible feature is to use the existing 4G and 5G multicast/broadcast service (MBS) solution defined by 3GPP. This feature is application agnostic but has not been tried to support UAS. There is no centralized network-based DAA solution for V2X being defined in the 3GPP which can be used for UAS.

### Example Embodiments

The embodiment technical solutions solve the above technical limitations of the conventional systems. This disclosure provides the technical solutions where a cellular base station may act as a ground station for UAS DAA to broadcast overall traffic information in a particular location/area to the cellular connected UASs via cellular connections. This disclosure provides solutions which use the mobile network to broadcast or multicast UAS traffic information to mobile (4G, 5G, and/or xG) connected UAV(s) and UAV controller(s). A mobile connected UAV or UAV controller may or may not subscribe the same mobile operator which operates the broadcasting of UAS traffic information.

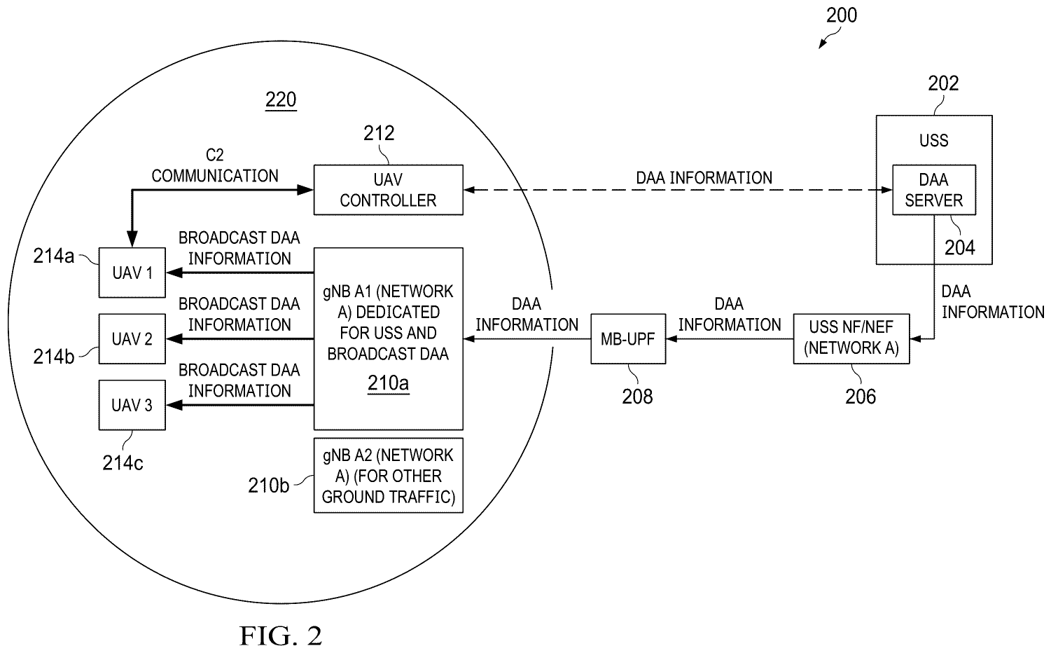

FIG. 2 shows an example architecture 200 of the embodiment solutions. A UAS service supplier (USS) 202 includes a DAA server 204, which may run on one or more network devices. The DAA server 204 may collect local UAS traffic information for DAA including DAA information of devices in the coverage area 220 of the network A. The DAA server 204 may transmit the DAA information to UAV controllers in the coverage area 220, such as the UAV controller 212. The UAV controller 212 can relay the DAA information to the UAV(s) (e.g., the UAV 214a) controlled by the UAV controller 212 through C2 communications. The UAV controller 212, the UAV 214a, or a combination of the UAV controller 212 and the UAV 214 may be considered as a UAS.

In addition, the DAA server 204 may send the DAA information to the USS network function (NF)/network exposure function (NEF) 206 of the network A. The NF/NEF 206 may run on one or more network devices. The USS NF/NEF 206 may forward the DAA information to a multicast-broadcast (MB) user plane function (UPF) 208, which may run on one or more network devices. The MB UPF 208 then forwards the DAA information to the base station 210a of the network A. The base station 210a may be a dedicated base station for broadcasting/multicasting the DAA information to UAVs, such as the UAVs 214a, 214b, and 214c. The network A may also include other base station(s), such as the base station 210b, that handle traffic other than the DAA information traffic. The UAVs in the coverage area 220 of the network A may or may not be subscribed to the network A. So the network A may or may not be the home network of the UAVs in the coverage area 220.

### UE Receiving Network Selection Policy for UAS DAA Broadcast/Multicast Network

In order for a UAV to receive the DAA information (e.g., local UAS traffic information for DAA), the UAV needs to identify and access a network which provides the UAS DAA broadcast/multicast service. The UAV may use a (stored) network selection policy provided to the UAV's home network. The home network owns the subscription of the UAV to identify and access the network that provides the UAS DAA broadcast/multicast service.

An embodiment includes utilizing a new network and cell selection policy. This new policy may be created by the UAV's home network which owns the communication service subscription of the UAV. The new network and cell selection policy is for the UAV to select the network or the cell that provides the UAS DAA broadcast/multicast service (e.g., multicasting/broadcasting the local traffic information for DAA purposes). A multicast/broadcast transmission may be considered as a point-to-multipoint (P2M) transmission. With Rel-17 NR, a multicast transmission can become a point-to-point (P2P) transmission. This new network and cell selection policy can be provisioned to the UAV by the home network by, for example, enhancing the UE policy update procedure or the UE route selection policy (URSP) defined in 3GPP TS23.501 and TS23.502. The UAV can use the provisioned network and cell selection policy to select the network (or cell) for DAA purpose.

For a UAV to identify and select the UAS DAA broadcast/multicast network/cell, an embodiment may use new UAV DAA identifier(s) associated with the selected network/cell. This new identifier can be defined as a DAA network ID or a DAA service ID. The DAA network ID can be used together with the existing network identifier (e.g. PLMN ID or NID) as a unique identifier to assist UE to identify whether a network or cell broadcasts/multicasts the DAA information. For ease of explanation, some embodiments are described using the DAA network ID for identifying a network for broadcasting/multicasting the DAA information. These embodiments can also be applicable when the new ID is used to identify a cell for broadcasting/multicasting the DAA information.

In various embodiments, the DAA network ID can be defined as a new type of network ID to indicate that the network identified by the DAA network ID provides UAS traffic management information. The DAA network ID can be used for the same network which may have other network ID(s) for providing other different non-UAS service(s). For example. Operator A has a network in an area (e.g., the coverage area 220) with PLMN ID 1. But the same network in the area can also be assigned with an additional DAA network ID 8 if the network broadcasts/multicasts DAA information (e.g., UAV traffic information). The unique identification of the network in the area (e.g., the coverage area 220) can be a combination of the PLMN ID (1) and DAA network ID (8).

In some embodiments, the DAA network ID can be a local ID used in one region or country, or can be global ID and assigned by a global entity.

In some embodiments, the service type of a DAA service ID is an ID assigned to identify the DAA service provided by the network. There can be several DAA service IDs even in the same network because there can be different levels of the DAA information, such as accuracy level, traffic area range, traffic type (e.g., whether the traffic includes crewed plane traffic), or other additional information, such as weather, and so on. This service type of the DAA network ID can be further classified into additional levels in accordance to the types of information provided.

In some embodiments, there can be a common UAS DAA ID which can be the combination of different types of DAA network IDs and further divided into multiple fields. One example is that the ID can be expressed as having three parts. The first part identifies DAA service(s) supported or provided. The second part indicates the DAA network ID. The third part indicates the type of DAA service. For instance, the DAA ID may be 16 bits. The first bit may be a DAA capability indicator. The next 8 bits may be allocated for the UAS network ID. The remaining bits can indicate the type of DAA information provided.

With the new DAA IDs described above, the new DAA network selection policy may be used in the following embodiments.

In some embodiments, the UAS DAA ID(s) list (e.g., network DAA ID list and DAA service ID list) may be added as the selection criteria. The UAV can only select the network(s)/cell(s) which broadcast/transmit those IDs. In an embodiment, the list may be organized in the order of the selection priority of the DAA ID(s).

In some embodiments, a selection condition for UAS DAA traffic information broadcast/multicast capability support may be added, such as whether the layer 2 and/or layer 3 MBS capability is required. The layer-2-based or layer-3-based MBS capability may be mapped to the 2 different MBS delivery mechanisms defined in 3GPP (TS23.247): individual MBS traffic delivery method (layer-3-based, IP based MBS) and shared MBS traffic delivery method (layer-2-based, require a radio access network (RAN) that supports MBS capability).

In some embodiments, because there can be a dedicated cell or base station (e.g., gNB) for the UAS DAA MBS service, the network selection policy can be enhanced to define the selection granularity to per network, or per cell for a particular network, new selection validity conditions, such as coverage area, time of the broadcast/multicast information, and so on.

In some embodiments, a new DAA group ID list for the industry consortium of which the home operator of the UAV is the member may be used, and no subscription may be required to receive the uncrewed aerial system traffic management (UTM) traffic information from any network within the group. A UAV can select a network belonging to the group. The UAV may select the network which broadcasts its DAA group ID matching an ID in the DAA group ID list.

In some embodiments, the DAA network selection policy can be implemented as part of aerial subscription which is defined in TS23.256.

The 5GC individual MBS traffic delivery method described above may only be applied for multicast MBS session(s). The 5G core network (5GC) may receive a single copy of the MBS data packets and deliver separate copies of those MBS data packets to individual UEs (e.g. UAVs) via the per-UE PDU sessions. So, for each such UE, one PDU session may be required to be associated with a multicast session.

The 5GC shared MBS traffic delivery method may be applied for both broadcast and multicast MBS session(s). The 5GC may receive a single copy of MBS data packets and delivers a single copy of those MBS packets to a next generation (NG)-RAN node, which then delivers the packets to one or multiple UEs (e.g., UAVs).

### UE Detection and Selection of UAS DAA Broadcast Network Based on the Network Selection Policy

The UAV may scan and receive broadcast system information from the surrounding network, and use such system information to identify the suitable DAA network according to the stored DAA network selection policy. The broadcast system information may indicate an identifier. Embodiments this disclosure provide new network system broadcast mechanisms which allows the network to broadcast its DAA support information to the UAVs within its coverage.

In some embodiments, embodiments allow one or more base stations (e.g., gNB(s)) to be dedicated for broadcasting/multicasting the traffic information in a location/area. The base station(s) may broadcast the indication that the base station is a DAA-designated ground station which is broadcasting/multicasting the DAA information (e.g., local DAA traffic information). This indication can be broadcast by the base station(s) via a SIB message.

In some embodiments, the network (e.g., network A in FIG. 2) can also broadcast a dedicated UAS DAA ID, such as a DAA network ID and/or a DAA service ID. If the UAV detects such indication during the UAV's network discovery and selection process, and if the network matches UAV's network selection policy, the UAV may establish a connection to the base station to receive the broadcast DAA information.

In some embodiments, the designated base station (e.g., eNB/gNB) may also broadcast other DAA information which includes the IP address or ID of the DAA server in the cloud. That DAA server is a central database to provide real time UTM information such as the DAA information in that area. The UAV can forward the network ID or the DAA server ID and/or address received from the broadcast/multicast network to its UAV controller via C2 communication, which can also query the DAA information via other interfaces (e.g., the Internet).

In some embodiments, because the current 3GPP specifications support both layer 2 and layer 3 broadcast and/or multicast services, the DAA capability indication information being broadcast by the base station may also indicate the type of the DAA broadcast/multicast service (layer 2 or layer 3).

In some embodiments, the base station may also broadcast interested area information, which defines the coverage area of broadcast/multicast the DAA information (e.g., local traffic information).

### Receiving UAS DAA Information

In this disclosure, subscription to the UTM traffic information (e.g., DAA information) for DAA may or may not be required. In some other embodiments, DAA information with subscription may be required.

The DAA information may include the local UAV or crewed plane traffic information within a certain area. The DAA information may be transferred from the DAA server in the USS (e.g., the DAA server 204 in the USS 202) to the UAS (UAV and/or UAV controller), such as UAV controller 212, UAVs 214a, 214b, and 214c. The DAA information can be conveyed through the 3GPP system via a new dedicated DAA information container. The DAA information can also be part of a C2 aviation payload container or a UAS payload container, both of which are defined in TS23.256. There can be different ways for the UAV and its controller to receive the DAA information.

If the DAA information is received via layer 2 broadcasting from the local network, the UAS can receive the DAA information using the following methods.

In Method 1, the UE (e.g., UAV) may have the subscription of another mobile operator, which is not the same operator of the DAA information broadcast network. To receive the DAA information, the UAV may be required to have two cellular links (cells), with one link connected to the network that provides normal data communication to the UAV, while the other link (periodically) is for the DAA information broadcast network to receive the DAA information.

In Method 2, if the DAA information broadcast network is the same network to which the UE (e.g., UAV) has the subscription, the UAV may only need to periodically tune one of the UAV's receiver (Rx) to the cell which broadcasts the DAA information. A new rule of the URSP may be utilized to split the Rx with different paths.

In Method 3, if the DAA information broadcast network has the roaming relationship with the home mobile network of the UE (e.g., UAV), the UAV can roam into the DAA information broadcast network based on the UTM roaming policy provisioned by the home network of the UE or be steered by the home network to the DAA information broadcast network. The home network can steer the UAV to a DAA information broadcast network based on the trigger from UTM/USS by enhancing the N33 interface.

If the DAA information is received via layer 3 IP layer broadcast/multicast from the local network, the UAS can receive the DAA information using the following methods.

Method 4 may require the UE (e.g., UAV) to subscribe to a DAA MBS service. If the network providing DAA service (e.g., the DAA information broadcast/multicast network) is the same home network of the UAV, the UAV can conduct the service subscription procedure with the DAA information broadcast/multicast network; otherwise, the UAV may roam into the DAA information broadcast/multicast network to receive DAA service.

In Method 5, the UE (e.g., UAV) still stays in the same network in which it is connected to. Method 5 may use the DAA server address broadcasted by the DAA information broadcast/multicast network to establish an Internet connection with that DAA server without switching to the DAA information broadcast/multicast network.

In order for the UAV to receive the multicast UTM traffic information (e.g., the DAA information), the UAV may be required to send certain join/keep alive message(s) to the USS to keep the UAV in the multicast group. The message may include the UAV's location, speed, and other traffic information. The USS or DAA server can based on the information from the joined members in that group to provide traffic information tailored to the group.

UAS DAA gNB/Network Discovery and Selection Based on the New Network Selection Policy

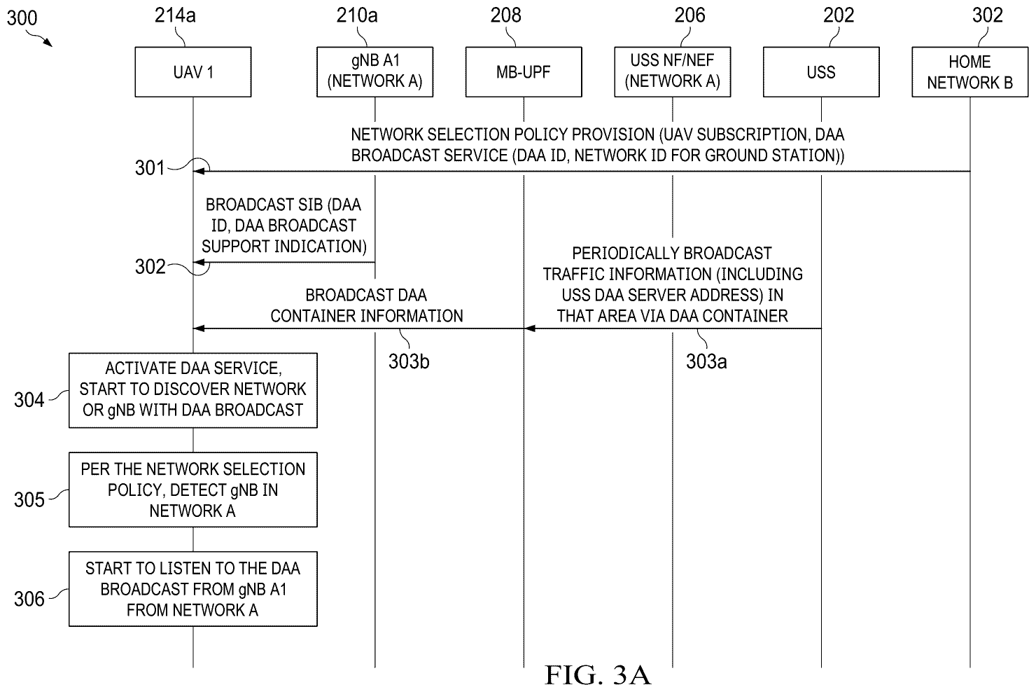

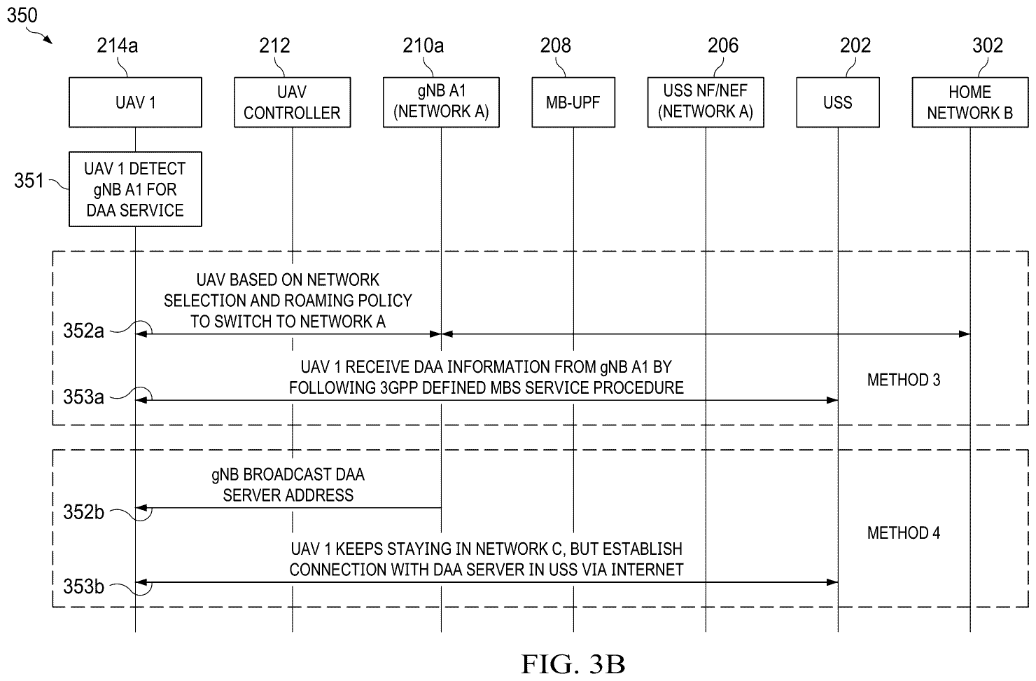

FIG. 3A shows a flow chart 300 for selection of a DAA information broadcast/multicast network (e.g., the network A in FIG. 2), according to some embodiments. At operation 301, the cellular connected UAV 214a has a UAS subscription which includes a network selection policy. The network selection policy guides the UAV 214a to select a network that supports UTM, including DAA (e.g., providing local UAS traffic information). The home network 302 of the UAV 214a can provision the network selection policy to the UAV 214a. The network selection policy may include the network ID of the DAA broadcast/multicast network (e.g., network A in FIG. 2), and the common DAA ID. The network selection policy can be provisioned as part of network selection policy or a URSP update via a UE parameter update (UPU)/UE configuration update (UCU) message to the UAV.

At operation 302, the DAA information broadcast/multicast network (e.g., network A) may allocate and configure the base station 210a as the DAA ground station to broadcast/multicast the DAA information to all the UASs in the area (e.g., the coverage area 220). The base station 210a may send a system information block (SIB) broadcast message with the indication of the base station's supporting the DAA information broadcast/multicast, the common DAA ID, and/or other DAA capability indicators. In some embodiment, the network A may configure only one base station (e.g., base station 210a) in the network to broadcast the DAA information. In some other embodiments, the network A can configure some or all of the base stations in the network to broadcast the DAA information.

At operation 303, the USS 202 may periodically send broadcast/multicast DAA information to network A via the USS NF/NEF 206 of the network A (303a of the operation 303). Then, the DAA information is broadcast/multicast via the base station 210a using a defined 3GPP MBS service (303b of the operation 303). The DAA information from the USS 202 can be transferred within a dedicated DAA information container or be part of C2 aviation payload defined in TS23.256 to the UAV through the 3GPP network MBS service.

At operation 304, the UAV 214a flies into the coverage area of the network A (e.g., the coverage area 220). The UAV214a activates the DAA service and starts to search for any ground station to receive the DAA information from.

At operation 305, the UAV 214a receives broadcast SIBs from one or more nearby networks. The UAV 214a checks each received broadcast SIB to see whether the received network ID and common DAA ID information match the UAV's stored network selection policy. Based on the UAV's stored network selection policy, the UAV 214a selects network A, and selects the base station 210a (or a cell of the network A) as the DAA ground station that broadcasts/multicasts the DAA information.

At operation 306, the UAV 214a connects to the base station 210a to receive the DAA information broadcast/multicast by the base station 210a of the network A.

### UAV Receiving the DAA Information

FIG. 3B shows a flow chart 350 for the UE (e.g., UAS or UAV) to receive the DAA information from the base station, according to some embodiments. At operation 351, the UAV 214a detects the network B (e.g., the home network 302) and the base station 210a for the DAA service.

For the UE (e.g., UAS or UAV) to receive the DAA information, Method 3 or Method 4 described above may be utilized.

Method 3 is used for layer 2 broadcast. At operation 352a, based on the network selection policy for the UAV 214a, (which is provisioned and stored in the UAV 214a), UAV 214a roams into the network A. At operation 353a (corresponding to the operation 303 in FIG. 3A), the UAV 214a receives the DAA information from the base station 210a (via or bypassing the UAV controller 212), following the defined 3GPP MBS service procedure.

Method 4 is for layer 3 broadcast. At operation 352b, the base station 210a provides the DAA server address and layer 3 broadcast indication in its SIB broadcast information. At operation 353b, the UAV 214a stays in the current network (e.g., the home network 302), to which the UAV 214a is connected. The UAV 214a may use the DAA server address received from the base station 210a to establish an Internet connection with the DAA server in the USS 202 via the home network 302 and receive the DAA information (via or bypassing the UAV controller 212).

The present disclosure may be applicable to both LTE, NR, and beyond.

The present disclosure may be combined with existing techniques based on Uu or non-3GPP technologies, or unlicensed band as the baseline.

FIG. 4A illustrates a flow chart of a method 400 performed by an uncrewed aerial system (UAS) (such as a UAV, the UAV controller, or a combination of the UAV and the UAV controller), according to some embodiments. The UAS may include computer-readable code or instructions executing on one or more processors of the UAS. Coding of the software for carrying out or performing the method 400 is well within the scope of a person of ordinary skill in the art having regard to the present disclosure. The method 400 may include additional or fewer operations than those shown and described and may be carried out or performed in a different order. Computer-readable code or instructions of the software executable by the one or more processors may be stored on a non-transitory computer-readable medium, such as for example, the memory of the UAS.

At the operation 402, the UAS receives, from a first network function device of a first network, a network selection policy. The network selection policy indicates a second network providing local UAS traffic information.

At the operation 404, the UAS receives from a second network function device (e.g., a base station) of the second network, uncrewed aerial system traffic management (UTM) support information.

At the operation 406, the UAS selects the second network in accordance to the network selection policy and the UTM support information.

At the operation 408, the UAS connects to the second network function device of the second network to receive the local UAS traffic information from the second network function device.

In some embodiments, the first network may be a home network that the UAS subscribes to. The second network may be different from the first network.

In some embodiments, the second network may be part of a network of the base station or of a cell of the base station.

In some embodiments, the UTM support information may be broadcast by the second network function device.

In some embodiments, the local UAS traffic information may be multicast or broadcast by the second network function device. In some embodiments, the second network function device may be the base station or an internet protocol (IP) based function device.

In some embodiments, the local UAS traffic information may be unicast by the second network function device.

In some embodiments, the UTM support information may indicate that the second network function device of the second network supports UTM including at least one of UAS identification or UAS detect and avoid (DAA).

In some embodiments, the second network function device may be a ground-based base station. The UAS may be at least one of an uncrewed aerial vehicle (UAV) or a UAV controller controlling the UAV.

In some embodiments, the network selection policy may include at least one of a candidate network identifier (ID) or a candidate DAA ID. The UTM support information may include a network ID of the second network and a DAA network ID. In some embodiments, the DAA network ID may indicate that a network is for UTM. The DAA network ID may be different from network ID(s) for providing other different non-UAS service(s). In some embodiments, the UE may select the second network based on the network ID in the UTM support information matching the candidate network ID in the network selection policy and the DAA network ID in the UTM support information matching the candidate DAA ID in the network selection policy. In some embodiments, the UE may select the second network based on a coverage area in which the UAS is located and a candidate coverage area indicated in the UTM support information. In some embodiments, the UAS may provide location information to the second network function device. The second network function device may provide traffic information tailored to a group of joined member devices based on information from joined member devices in the group, and the group may include the UAS.

In some embodiments, wherein the network selection policy may further define a selection granularity per network, or per cell of the second network.

FIG. 4B illustrates a flow chart of a method 450 performed by a second network function device of a second network (such as the base station 212a), according to some embodiments. The second network function device may include computer-readable code or instructions executing on one or more processors of the second network function device. Coding of the software for carrying out or performing the method 450 is well within the scope of a person of ordinary skill in the art having regard to the present disclosure. The method 450 may include additional or fewer operations than those shown and described and may be carried out or performed in a different order. Computer-readable code or instructions of the software executable by the one or more processors may be stored on a non-transitory computer-readable medium, such as for example, the memory of the second network function device.

At the operation 452, the second network function device of the second network transmits to an uncrewed aerial system (UAS), uncrewed aerial system traffic management (UTM) support information. The UAS receives from a first network function device of a first network, a network selection policy indicating the second network providing local UAS traffic information. The UAS selects the second network in accordance to the network selection policy and the UTM support information.

At the operation 454, the second network functioned device of the second network connects with the UAS to transmit the local UAS traffic information from the second network function device.

In some embodiments, the first network may be a home network that the UAS subscribes to. The second network may be different from the first network.

In some embodiments, the second network may be part of a network of the base station or of a cell of the base station.

In some embodiments, the UTM support information may be broadcast by the second network function device.

In some embodiments, the local UAS traffic information may be multicast or broadcast by the second network function device. In some embodiments, the second network function device may be the base station or an internet protocol (IP) based function device.

In some embodiments, the local UAS traffic information may be unicast by the second network function device.

In some embodiments, the UTM support information may indicate that the second network function device of the second network supports UTM including at least one of UAS identification or UAS detect and avoid (DAA).

In some embodiments, the second network function device may be a ground-based base station. The UAS may be at least one of an uncrewed aerial vehicle (UAV) or a UAV controller controlling the UAV.

In some embodiments, the network selection policy may include at least one of a candidate network identifier (ID) or a candidate DAA ID. The UTM support information may include a network ID of the second network and a DAA network ID. In some embodiments, the DAA network ID indicate that a network is for UTM. The DAA network ID may be different from any network ID(s) for providing other different non-UAS service(s). In some embodiments, the UE may select the second network based on the network ID in the UTM support information matching the candidate network ID in the network selection policy and the DAA network ID in the UTM support information matching the candidate DAA ID in the network selection policy. In some embodiments, the UE may select the second network based on a coverage area in which the UAS is located and a candidate coverage area indicated in the UTM support information. In some embodiments, the UAS may provide location information to the second network function device. The second network function device may provide traffic information tailored to a group of joined member devices based on information from the joined member devices in the group, and the group may include the UAS.

In some embodiments, wherein the network selection policy may further define a selection granularity per network, or per cell of the second network.

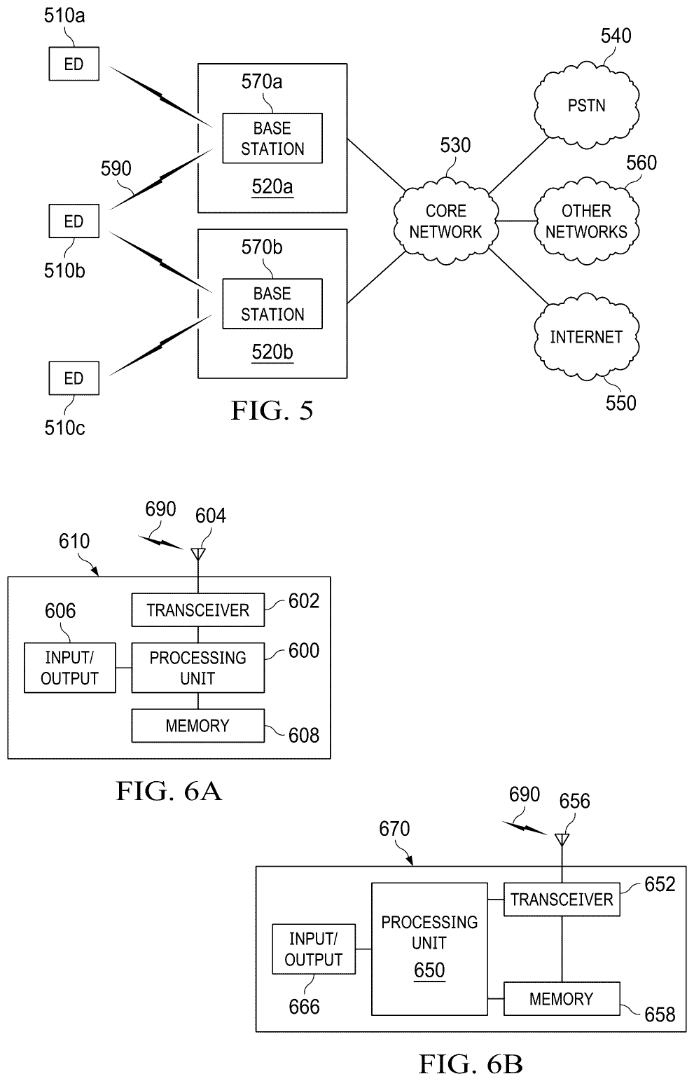

FIG. 5 illustrates an example communication system 500. In general, the system 500 enables multiple wireless or wired users to transmit and receive data and other content. The system 500 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 500 includes electronic devices (ED) 510a-510o, radio access networks (RANs) 520a-520b, a core network 530, a public switched telephone network (PSTN) 540, the Internet 550, and other networks 560. While certain numbers of these components or elements are shown in FIG. 5, any number of these components or elements may be included in the system 500.

The EDs 510a-510c are configured to operate or communicate in the system 500. For example, the EDs 510a-510c are configured to transmit or receive via wireless or wired communication channels. Each ED 510a-510c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 520a-520b here include base stations 570a-570b, respectively. Each base station 570a-570b is configured to wirelessly interface with one or more of the EDs 510a-510c to enable access to the core network 530, the PSTN 540, the Internet 550, or the other networks 560. For example, the base stations 570a-570b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 510a-510c are configured to interface and communicate with the Internet 550 and may access the core network 530, the PSTN 540, or the other networks 560.

In the embodiment shown in FIG. 5, the base station 570a forms part of the RAN 520a, which may include other base stations, elements, or devices. Also, the base station 570b forms part of the RAN 520b, which may include other base stations, elements, or devices. Each base station 570a-570b operates to transmit or receive wireless signals within a particular geographic region or area, sometimes referred to as a “cell.” In some embodiments, multiple-input multiple-output (MIMO) technology may be employed having multiple transceivers for each cell.

The base stations 570a-570b communicate with one or more of the EDs 510a-510c over one or more air interfaces 590 using wireless communication links. The air interfaces 590 may utilize any suitable radio access technology.

It is contemplated that the system 500 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 520a-520b are in communication with the core network 530 to provide the EDs 510a-510c with voice, data, application, Voice over Internet Protocol (VoIP), or other services. Understandably, the RANs 520a-520b or the core network 530 may be in direct or indirect communication with one or more other RANs (not shown). The core network 530 may also serve as a gateway access for other networks (such as the PSTN 540, the Internet 550, and the other networks 560). In addition, some or all of the EDs 510a-510c may include functionality for communicating with different wireless networks over different wireless links using different wireless technologies or protocols. Instead of wireless communication (or in addition thereto), the EDs may communicate via wired communication channels to a service provider or switch (not shown), and to the Internet 550.

Although FIG. 5 illustrates one example of a communication system, various changes may be made to FIG. 5. For example, the communication system 500 could include any number of EDs, base stations, networks, or other components in any suitable configuration.

FIGS. 6A and 6B illustrate example devices that may implement the methods and teachings according to this disclosure. In particular, FIG. 6A illustrates an example ED 610, and FIG. 6B illustrates an example base station 670. These components could be used in the system 500 or in any other suitable system.

As shown in FIG. 6A, the ED 610 includes at least one processing unit 600. The processing unit 600 implements various processing operations of the ED 610. For example, the processing unit 600 could perform signal coding, data processing, power control, input/output processing, or any other functionality enabling the ED 610 to operate in the system 1000. The processing unit 600 also supports the methods and teachings described in more detail above. Each processing unit 600 includes any suitable processing or computing device configured to perform one or more operations. Each processing unit 600 could, for example, include a microprocessor, microcontroller, digital signal processor, field programmable gate array, or application specific integrated circuit.

The ED 610 also includes at least one transceiver 602. The transceiver 602 is configured to modulate data or other content for transmission by at least one antenna or NIC (Network Interface Controller) 604. The transceiver 602 is also configured to demodulate data or other content received by the at least one antenna 604. Each transceiver 602 includes any suitable structure for generating signals for wireless or wired transmission or processing signals received wirelessly or by wire. Each antenna 604 includes any suitable structure for transmitting or receiving wireless or wired signals. One or multiple transceivers 602 could be used in the ED 610, and one or multiple antennas 604 could be used in the ED 610. Although shown as a single functional unit, a transceiver 602 could also be implemented using at least one transmitter and at least one separate receiver.

The ED 610 further includes one or more input/output devices 606 or interfaces (such as a wired interface to the Internet 550). The input/output devices 606 facilitate interaction with a user or other devices (network communications) in the network. Each input/output device 606 includes any suitable structure for providing information to or receiving information from a user, such as a speaker, microphone, keypad, keyboard, display, or touch screen, including network interface communications.

In addition, the ED 610 includes at least one memory 608. The memory 608 stores instructions and data used, generated, or collected by the ED 610. For example, the memory 608 could store software or firmware instructions executed by the processing unit(s) 600 and data used to reduce or eliminate interference in incoming signals. Each memory 608 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 6B, the base station 670 includes at least one processing unit 650, at least one transceiver 652, which includes functionality for a transmitter and a receiver, one or more antennas 656, at least one memory 658, and one or more input/output devices or interfaces 666. A scheduler, which would be understood by one skilled in the art, is coupled to the processing unit 650. The scheduler could be included within or operated separately from the base station 670. The processing unit 650 implements various processing operations of the base station 670, such as signal coding, data processing, power control, input/output processing, or any other functionality. The processing unit 650 can also support the methods and teachings described in more detail above. Each processing unit 650 includes any suitable processing or computing device configured to perform one or more operations. Each processing unit 650 could, for example, include a microprocessor, microcontroller, digital signal processor, field programmable gate array, or application specific integrated circuit.

Each transceiver 652 includes any suitable structure for generating signals for wireless or wired transmission to one or more EDs or other devices. Each transceiver 652 further includes any suitable structure for processing signals received wirelessly or by wire from one or more EDs or other devices. Although shown combined as a transceiver 652, a transmitter and a receiver could be separate components. Each antenna 656 includes any suitable structure for transmitting or receiving wireless or wired signals. While a common antenna 656 is shown here as being coupled to the transceiver 652, one or more antennas 656 could be coupled to the transceiver(s) 652, allowing separate antennas 656 to be coupled to the transmitter and the receiver if equipped as separate components. Each memory 658 includes any suitable volatile or non-volatile storage and retrieval device(s). Each input/output device 666 facilitates interaction with a user or other devices (network communications) in the network. Each input/output device 666 includes any suitable structure for providing information to or receiving/providing information from a user, including network interface communications.

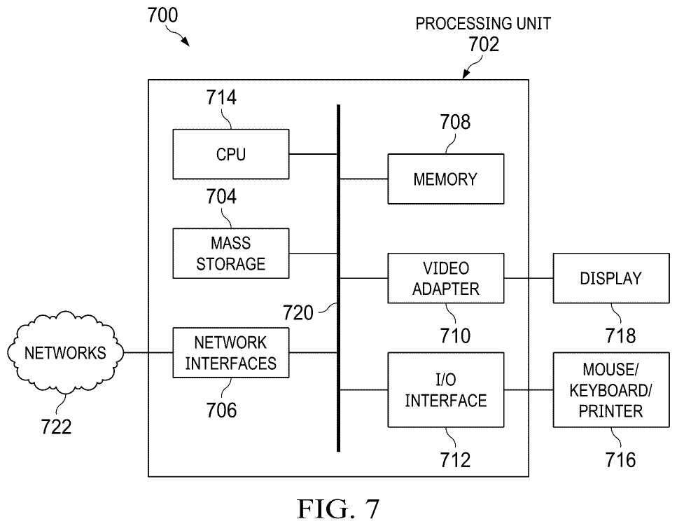

FIG. 7 is a block diagram of a computing system 700 that may be used for implementing the devices and methods disclosed herein, according to some embodiments. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 700 includes a processing unit 702. The processing unit includes a central processing unit (CPU) 714, memory 708, and may further include a mass storage device 704, a video adapter 710, and an I/O interface 712 connected to a bus 720.

The bus 720 may be one or more of any type of several bus architectures including a memory bus or memory controller, a peripheral bus, or a video bus. The CPU 714 may comprise any type of electronic data processor. The memory 708 may comprise any type of non-transitory system memory such as static random access memory (SRAM), dynamic random access memory (DRAM), synchronous DRAM (SDRAM), read-only memory (ROM), or a combination thereof. In an embodiment, the memory 708 may include ROM for use at boot-up, and DRAM for program and data storage for use while executing programs.

The mass storage 704 may comprise any type of non-transitory storage device configured to store data, programs, and other information and to make the data, programs, and other information accessible via the bus 720. The mass storage 704 may comprise, for example, one or more of a solid state drive, hard disk drive, a magnetic disk drive, or an optical disk drive.

The video adapter 710 and the I/O interface 712 provide interfaces to couple external input and output devices to the processing unit 702. As illustrated, examples of input and output devices include a display 718 coupled to the video adapter 710 and a mouse, keyboard, or printer 716 coupled to the I/O interface 712. Other devices may be coupled to the processing unit 702, and additional or fewer interface cards may be utilized. For example, a serial interface such as Universal Serial Bus (USB) (not shown) may be used to provide an interface for an external device.

The processing unit 702 also includes one or more network interfaces 706, which may comprise wired links, such as an Ethernet cable, or wireless links to access nodes or different networks. The network interfaces 706 allow the processing unit 702 to communicate with remote units via the networks. For example, the network interfaces 706 may provide wireless communication via one or more transmitters/transmit antennas and one or more receivers/receive antennas. In an embodiment, the processing unit 702 is coupled to a local-area network 722 or a wide-area network for data processing and communications with remote devices, such as other processing units, the Internet, or remote storage facilities.

It should be appreciated that one or more steps of the embodiment methods provided herein may be performed by corresponding units or modules. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method performed by an uncrewed aerial system (UAS), the method comprising:
receiving from a first network function device of a first network, a network selection policy indicating a second network providing local UAS traffic information;
receiving from a second network function device of the second network, uncrewed aerial system traffic management (UTM) support information;
selecting the second network in accordance to the network selection policy and the UTM support information; and
connecting to the second network function device to receive the local UAS traffic information from the second network function device.

2. The method of claim 1, wherein the first network is a home network that the UAS subscribes to, and the second network is different from the first network.

3. The method of claim 1, wherein the second network is part of a network of a base station or of a cell of the base station.

4. The method of claim 1, wherein the UTM support information is broadcast by the second network function device.

5. The method of claim 1, wherein the local UAS traffic information is multicast or broadcast by the second network function device.

6. The method of claim 5, wherein the second network function device is a base station or an internet protocol (IP) based function device.

7. The method of claim 1, wherein the local UAS traffic information is unicast by the second network function device.

8. The method of claim 1, the UTM support information indicating that the second network function device of the second network supports UTM including at least one of UAS identification or UAS detect and avoid (DAA).

9. The method of claim 1, wherein the second network function device is a ground-based base station or an internet protocol (IP) based function device, and the UAS is at least one of an uncrewed aerial vehicle (UAV) or a UAV controller controlling the UAV.

10. The method of claim 1, wherein the UAS provides location information to the second network function device, the second network function device providing traffic information tailored to a group of joined member devices based on information from the joined member devices in the group, and wherein the group includes the UAS.

11. A method, comprising:
transmitting, by a second network function device of a second network to an uncrewed aerial system (UAS), uncrewed aerial system traffic management (UTM) support information, the UAS receiving from a first network function device of a first network, a network selection policy indicating the second network providing local UAS traffic information, the UAS selecting the second network in accordance to the network selection policy and the UTM support information; and
connecting, by the second network function device of the second network with the UAS to transmit the local UAS traffic information from the second network function device.

12. The method of claim 11, wherein the first network is a home network that the UAS subscribes to, and the second network is different from the first network.

13. The method of claim 11, wherein the UTM support information is broadcast by the second network function device.

14. The method of claim 11, wherein the local UAS traffic information is multicast or broadcast by the second network function device.

15. The method of claim 14, wherein the second network function device is a base station or an internet protocol (IP) based function device.

16. The method of claim 11, wherein the local UAS traffic information is unicast by the second network function device.

17. The method of claim 11, the UTM support information indicating that the second network function device of the second network supports UTM including at least one of UAS identification or UAS detect and avoid (DAA).

18. The method of claim 11, wherein the second network function device is a ground-based base station or an internet protocol (IP) based function device, and the UAS is at least one of an uncrewed aerial vehicle (UAV) or a UAV controller controlling the UAV.

19. The method of claim 11, wherein the network selection policy includes at least one of a candidate network identifier (ID) or a candidate DAA ID, and UTM support information includes a network ID of the second network and a DAA network ID.

20. The method of claim 11, wherein the UAS provides location information to the second network function device, wherein the second network function device provides traffic information tailored to a group of joined member devices based on information from the joined member devices in the group, and wherein the group includes the UAS.

21. An uncrewed aerial system (UAS), comprising:
at least one processor; and
a non-transitory computer readable storage medium storing programming that, when executed by the at least one processor, cause the UAS to perform operations including:
receiving from a first network function device of a first network, a network selection policy indicating a second network providing local UAS traffic information;
receiving from a second network function device of the second network, uncrewed aerial system traffic management (UTM) support information;
selecting the second network in accordance to the network selection policy and the UTM support information; and
connecting to the second network function device to receive the local UAS traffic information from the second network function device.

22. A second network function device, comprising:
at least one processor; and
a non-transitory computer readable storage medium storing programming that, when executed by the at least one processor, cause the second network function device to perform operations including:
transmitting, to an uncrewed aerial system (UAS), uncrewed aerial system traffic management (UTM) support information, the UAS receiving from a first network function device of a first network, a network selection policy indicating a second network providing local UAS traffic information, the UAS selecting the second network in accordance to the network selection policy and the UTM support information; and
connecting, with the UAS to transmit the local UAS traffic information from the second network function device.
